(19) United States
(12) Patent Application Publication
(10) Pub. No.: US 2017/0348082 A1
(43) Pub. Date: Dec. 7, 2017

(54) Mouth-Cleaning Device for a Pet

(71) Applicant: Hill's Pet Nutrition, Inc., Topeka, KS (US)

(72) Inventor: Blair OGLEBY, Topeka, KS (US)

(73) Assignee: Hill's Pet Nutrition, Inc., Topeka, KS (US)

(21) Appl. No.: 15/539,789

(22) PCT Filed: Dec. 27, 2014
(86) PCT No.: PCT/US2014/072458

§ 371 Date: Jun. 26, 2017

(51) Int. Cl. A61D 5/00; A01K 5/01; A01K 15/02

(52) U.S. Cl. CPC A61D 5/00; A01K 15/026; A01K 5/0114; A46B 2200/1086

(57) ABSTRACT

A mouth-cleaning device (100) for a pet. The device includes a base (110) and a side wall (120) extending from the base. The base and the side wall at least partially define an internal volume configured to receive a product. A plurality of protrusions (112, 122) extends from the base or the side wall, or both. The protrusions are configured to engage an oral tissue of a pet.

### BACKGROUND

Oral hygiene is as important for pets as it is for people. Lack of proper oral hygiene may result in a pet having bad breath and, in some cases, oral (e.g., periodontal) disease. For example, more than 50% of dogs and cats show some signs of oral disease by the age of three, according to the American Veterinary Dental Society. Bad breath and oral disease may be the result of plaque, tartar, and microorganisms in the mouth of a pet.

To reduce the presence of plaque, tartar, and microorganisms, many pet owners use a toothbrush and toothpaste to clean the mouth of their pet. However, this may prove difficult and unpleasant as most pets tend to resist a mouth cleaning. In addition, many pet owners fail to brush the teeth of their pet on a regular basis. Another way to clean the mouth of a pet is to provide the pet with a “chew toy.” As the pet chews on the toy, the friction between the toy and parts within the mouth of the pet may dislodge plaque, tartar, and microorganisms. While needing less effort on the part of the pet owner than brushing, chew toys prove less effective at cleaning the mouth of a pet. Therefore, it may be desirable to provide an improved apparatus and method for cleaning the mouth of a pet.

### BRIEF SUMMARY

A mouth-cleaning device for a pet is disclosed. The device includes a base and a side wall extending from the base. The base and the side wall at least partially define an internal volume configured to receive a product. A plurality of protrusions extends from the base or the side wall, or both. The protrusions are configured to at least partially clean the mouth of the pet.

In another embodiment, the mouth-cleaning device includes a base having a first means for at least partially cleaning a mouth of a pet. A side wall may extend up from the base. The side wall has a second means for at least partially cleaning the mouth of the pet. A lid is coupled to the side wall. The base, the side wall, and the lid at least partially define an internal volume.

A method for cleaning a mouth of a pet is also disclosed. The method includes placing a product onto a base having a plurality of protrusions extending upwardly therefrom. The protrusions are configured to bend when contacted by the mouth of the pet as the pet consumes the product, thereby cleaning the mouth of the pet.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 depicts a perspective view of an illustrative mouth-cleaning device for a pet, according to an embodiment.

FIG. 2 depicts a cross-sectional view of the mouth-cleaning device shown in FIG. 1, according to an embodiment.

FIG. 3 depicts a perspective view of the mouth-cleaning device with a curved side wall, according to an embodiment.

FIG. 4 depicts a cross-sectional view of the mouth-cleaning device shown in FIG. 3, according to an embodiment.

FIG. 5 depicts a flowchart of a method for cleaning the mouth of a pet, according to an embodiment.

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

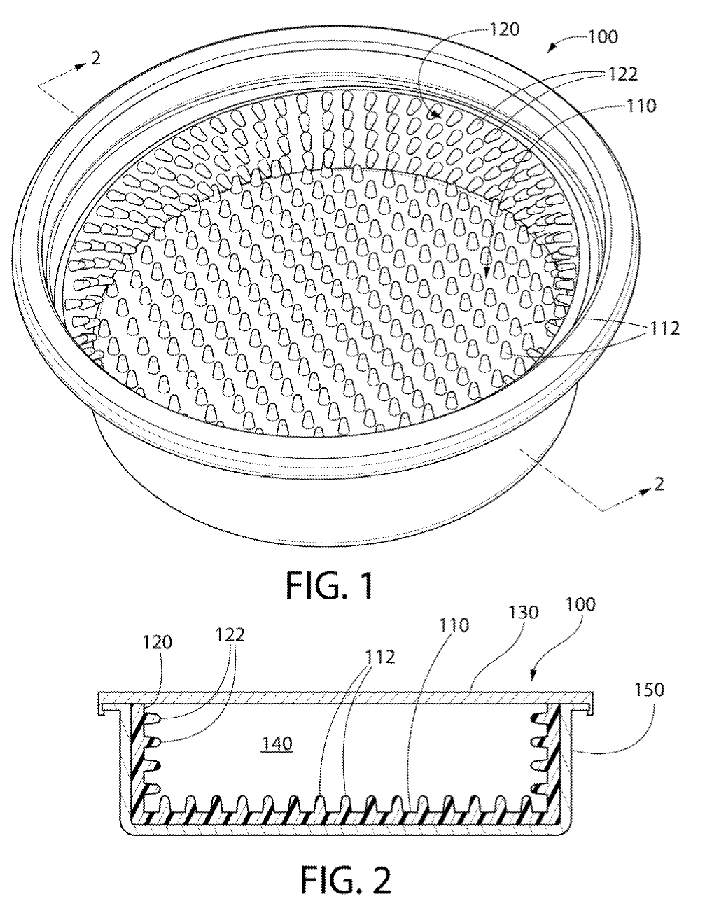

FIG. 1 depicts a perspective view of an illustrative mouth-cleaning device 100 for a pet, according to an embodiment. The device 100 may include a base 110. The shape of the base 110 may be a circle, an oval, a square, a rectangle, or any other shape. As shown, the base 110 is flat and circular so that the base 110 may be positioned in a bowl, a can, or a container 150. In some embodiments, the base 110 may be an integral part of a container 150 (see FIG. 2). The base 110 may be made from a metal, a polymer (e.g., rubber), an elastomer, or the like.

The base 110 may have one or more protrusions 112 extending (e,g., upwardly) therefrom. The protrusions 112 may be coupled to, or integral with, the base 110. The protrusions 112 extending from the base 110 may be substantially perpendicular to the base 110. For example, a central longitudinal axis through one of the protrusions 112 may be oriented at an angle from about 80° to about 100° (e.g., about 90°) with respect to the base 110. The protrusions 112 may be made of the same material as the base 110 or a different material than the base 110. For example, the protrusions 112 may be made from a metal, a polymer (e.g., rubber or NYLON®), an elastomer, hair (e.g., real or synthetic), or the like.

The protrusions 112 may each have the same length, or they may have different lengths. The length of the protrusions 112 may be from about 1 mm to about 20 mm, about 2 mm to about 15 mm, or about 3 mm to about 10 mm. The protrusions 112 may each have the same thickness (e.g., diameter), or the protrusions 112 may have different thicknesses. The thickness of the protrusions 112 may be from about 0.1 mm to about 5 mm, about 0.1 mm to about 1 mm, or about 1 mm to about 3 mm. As shown, the protrusions 112 may be oriented in a series of columns and rows, where the rows are perpendicular to the columns. However, as will be appreciated, the protrusions 112 may oriented in any manner on the base 110. A distance between two adjacent protrusions 112 may be from about 1 mm to about 10 mm, about 1 mm to about 5 mm, or about 1 mm to about 3 mm. As will be appreciated, the distance between adjacent protrusions 112 may vary in different sections of the device 100 (e.g., on the base 110 and side wall 120).

One or more side walls 120 may extend upward from the base 110. As shown, a single, circular side wall 120 extends around the periphery of the base 110. In other embodiments, the side wall 120 may include two or more portions (e.g., four portions when the base 110 is rectangular). In various embodiments, the side wall 120 may be coupled to, or integral with, the base 110. In some embodiments, the side wall 120 may be an integral part of the container 150.

The side wall 120 may have one or more protrusions 122 extending therefrom. More particularly, the protrusions 122 may extend inwardly (e.g., into an intemal volume) from the side wall 120. The protrusions 122 may be coupled to, or integral with, the side wall 120. The protrusions 122 extending from the side wall 120 may be substantially perpendicular to the side wall 120 (e.g., perpendicular to the points on the side wall 120 from which they extend). For example, a central longitudinal axis through one of the protrusions 122 may be oriented at an angle from about 80° to about 100° (e.g., about 90°) with respect to the side wall 120. The protrusions 122 may be made from the same material as the base 110, the side wall 120, or the protrusions 112.

The protrusions 112, 122 may be configured to bend or flex when contacted by an animal. More particularly, the protrusions 112, 122 may be configured to bend or flex when contacted by the teeth, gums, lips, or tongue of a pet. As such, the protrusions 112, 122 may function similarly to the bristles of a toothbrush and may serve to clean the mouth of the pet. In another embodiment, the protrusions 112, 122 may be rigid.

FIG. 2 depicts a cross-sectional view of the mouth-cleaning device 100 shown in FIG. 1, according to an embodiment. The cross-sectional shape of the protrusions 112, 122 may be cylindrical, conical, frustoconical, or the like. The materials, lengths, thicknesses, distances, and/or shapes of the protrusions 112, 122 may be mixed on the device 100. For example, one or more conical protrusions made of a polymer and one or more cylindrical protrusions made of hair/bristle may be positioned on the same base 110.

The cross-section of the side wall 120 may be planar and oriented at an angle with respect to the base 110. As shown, the angle is about 90°. In other embodiments, the angle may be from about 90° to about 179°, about 90° to about 120°, or about 120° to about 150°.

A lid 130 may be coupled to or contacted with the side wall 120 distal to the base 110. An internal volume 140 may be defined by the base 110, the side wall 120, and (when present) the lid 130. The lid 130 may be coupled to the side wall 120 via a threaded connection, using heat and pressure, or using ultrasound. As shown, in one embodiment, the device 100 may be positioned at least partially within a container (e.g., a bowl) 150.

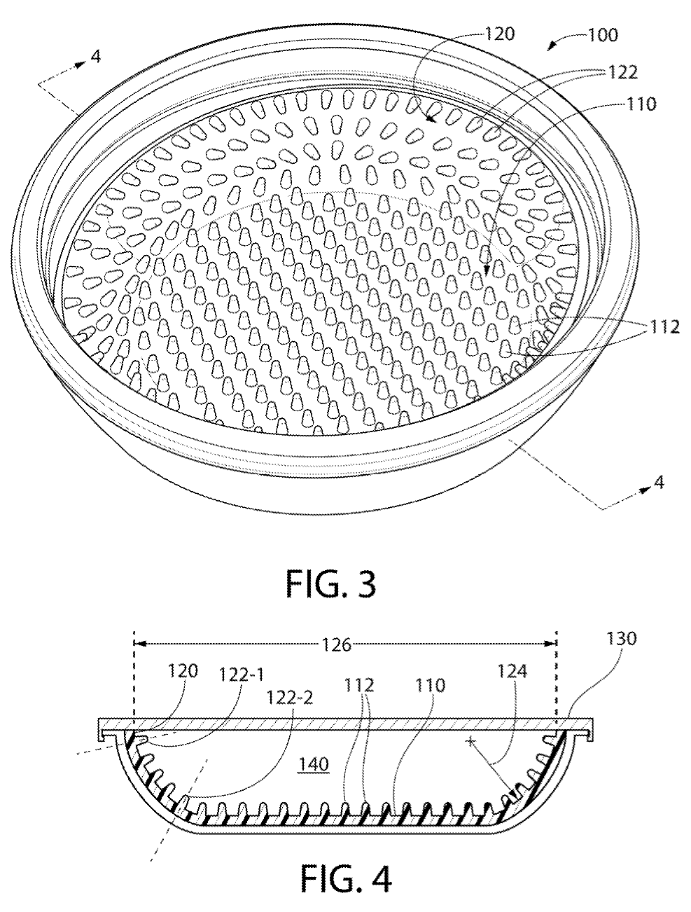

FIG. 3 depicts a perspective view of the mouth-cleaning device 100 with a curved side wall 120, and FIG. 4 depicts a cross-sectional view of the device 100 shown in FIG. 3, according to an embodiment. As shown in FIG. 3, the cross-section of the side wall 120 may be curved, rather than planar, moving away from the base 110 to create a “bowl” shape. For example, at least a portion of the side wall 120 may include a radius of curvature 124 that is from about 1 cm to about 20 cm, about 2 cm to about 15 cm, or about 3 cm to about 10 cm. As a result, a cross-sectional distance 126 between opposing portions of side wall 120 may increase moving away from the base 110.

The angles of the protrusions 122 on the side wall 120 with respect to the base 110 may vary based upon the positions of the protrusions 122 on the side wall 120 (e.g., the distance from the base 110). The angles of the protrusions 122 with respect to the base 110 may be from about 0° (distal to the base 110) to about 90° (proximate to the base 110). For example, an angle between a central longitudinal axis through a first protrusion 122-1 and the base 110 may be about 5°, and an angle between a central longitudinal axis through a second protrusion 122-2 and the base 110 may be about 80°.

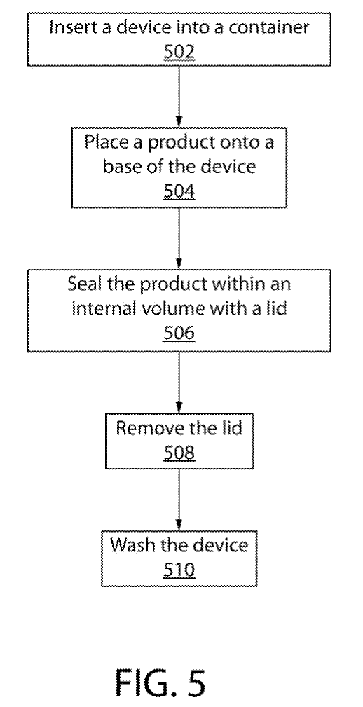

FIG. 5 depicts a flowchart of a method 500 for cleaning the mouth of a pet, according to an embodiment. The method 500 may begin by inserting the device 100 into a container 150, as at 502. In one embodiment, the device 100 may be lowered into the container 150 and lifted out of the container 150 when desired. The device 100 may be constrained from lateral movement due to contact between the outer surface of the side wall 120 of the device 100 with the inner surface of the side wall of the container 150. This may allow the device 100 to be lifted out of the container 150 and washed after use. In another embodiment, the device 100 may be secured to the container 150 with, for example, an adhesive. In yet another embodiment, the device 100 may be integral with the container 150. In yet another embodiment, the container 150 may be omitted altogether, e.g., the device 100 may be or act as a container.

A product, for example a food product for animals, may then be placed onto the base 110, as at 504. More particularly, the product may be placed in the internal volume 140 of the device 100. The product may be a liquid, a solid, a gel, a paste, or the like. For example, suitable liquids may be water, milk-replacer, a therapeutic solution (e.g., including electrolytes), or a mouth or oral rinse. Suitable solids may be food (e.g., “dry” pet food or “wet” pet food), stews, chunks, gravy, and the like. Suitable gels may include energy supplements gels. Suitable pastes may be SCIENCE DIET®, toothpaste, and the like.

In at least one embodiment, the product may be sealed within the internal volume 140 of the device 100 by coupling or contacting the lid 130 to the side wall 120, as at 506. This may be done by the manufacturer of the product or the pet owner. The lid 130 may then be removed, as at 508. This may be done by the pet owner. In some instances, steps 506 and 508 may be omitted.

As the pet consumes the product in the device 100, the protrusions 112, 122 in the device 100 may contact the mouth of the pet. More particularly, the protrusions 112, 122 may brush, scrub, or scrape off plaque, tartar, microorganisms, and the like from the teeth, gums, lips, tongue, and other mouth parts of the pet. Once the pet is finished eating the product, the device 100 may be discarded. In another embodiment, the device 100 may be washed, as at 510, for reuse. For example, the device 100 may be removed from the container 150 and washed.

What is claimed is:

1. A mouth-cleaning device for a pet, comprising:
a base;
a side wall extending from the base, wherein the base and the side wall at least partially define an internal volume configured to receive a product; and
a plurality of protrusions extending from the base or the side wall, or both,
wherein the plurality of protrusions are configured to engage an oral tissue of a pet.

2. The mouth-cleaning device of claim 1, wherein the protrusions extend upward from the base.

3. The mouth-cleaning device of claim 1, wherein the protrusions extend inward from the side wall.

4. The mouth-cleaning device of claim 1, wherein the protrusions are made from a polymer, an elastomer, or hair.

5. The mouth-cleaning device of claim 1, wherein the protrusions are configured to bend when contacted by an oral tissue of a pet.

6. The mouth-cleaning device of claim 1, wherein a length of the protrusions is from about 2 mm to about 15 mm, and wherein a thickness of the protrusions is from about 0.1 mm to about 5 mm.

7. The mouth-cleaning device of claim 1, wherein a central longitudinal axis through one of the protrusions is oriented at an angle from about 80 degrees to about 100 degrees with respect to the base.

8. The mouth-cleaning device of claim 1, wherein a central longitudinal axis through one of the protrusions is oriented at an angle from about 80 degrees to about 100 degrees with respect to the side wall.

9. The mouth-cleaning device of claim 1, wherein a central longitudinal axis through a first one of the protrusions on the side wall is oriented at a first angle with respect to the base, wherein a central longitudinal axis through a second one of the protrusions on the side wall is oriented at a second angle with respect to the base, and wherein the first angle is less than the second angle.

10. The mouth-cleaning device of claim 9, wherein the first one of the protrusions is positioned farther away from the base than the second one of the protrusions.

11. A mouth-cleaning device for a pet, comprising:
a base having a first plurality of protrusions extending upwardly therefrom;
a side wall extending from the base, wherein the side wall has a second plurality of protrusions extending inwardly therefrom; and
a lid coupled to the side wall, wherein the base, the side wall, and the lid at least partially define an internal volume,
wherein the first and second plurality of protrusions are configured to engage an oral tissue of a pet.

12. The mouth-cleaning device of claim 11, further comprising a product positioned within the internal volume.

13. The mouth-cleaning device of claim 12, wherein the product comprises pet food.

14. The mouth-cleaning device of claim 11, wherein the first and second pluralities of protrusions are made from a polymer, an elastomer, or hair.

15. The mouth-cleaning device of claim 11, wherein the first and second pluralities of protrusions are configured to bend when contacted by an oral tissue of pet.

16. A method for cleaning a mouth of a pet, comprising:
placing a product onto a base having a plurality of protrusions extending upwardly therefrom, wherein the protrusions are configured to bend when contacted by the mouth of the pet as the pet consumes the product, thereby cleaning the mouth of the pet.

17. The method of claim 16, further comprising placing the base into a bowl.

18. The method of claim 16, wherein a side wall extends upward from the base, and wherein the base and the side wall at least partially define an internal volume, and wherein the product is positioned in the internal volume.

19. The method of claim 16, further comprising sealing the product within the internal volume by coupling a lid to the side wall.

20. The method of claim 16, further comprising removing a lid coupled to the side wall to provide access to the product in the internal volume.
